(19) United States
(12) Patent Application Publication
(10) Pub. No.: US 2024/0343172 A1
(43) Pub. Date: Oct. 17, 2024

(54) GOLF CART SEAT COVER SYSTEM

(71) Applicant: David Dreher, Pass Christian, MS (US)

(72) Inventor: David Dreher, Pass Christian, MS (US)

(21) Appl. No.: 18/135,418

(22) Filed: Apr. 17, 2023

(51) Int. Cl. B60N 2/60

(52) U.S. Cl. CPC B60N 2/6054

(57) ABSTRACT

In accordance with embodiments of the invention, a cushion cover system is provided. The cushion cover system includes a removable cushion covers. The removable cushion covers include a slipcover having a top portion opposite a bottom portion. A peripheral opening is defined by the bottom portion of the slipcover. The removable cushion cover includes at least one buckle operable to secure a first side of the peripheral opening to a second side of the peripheral opening of the slipcover. The slipcovers are operable to receive and secure a cushion through the peripheral opening in the bottom portion of the backrest slipcover and the buckle is operable to secure the backrest cushion within the backrest slipcover.

### BACKGROUND OF THE INVENTION

### I. Field of the Invention

The present invention relates generally to coverings for golf cart seats.

### II. General Background

Golf carts are a ubiquitous mode of utility. Whether moving golfers around a course or people around a college campus or large area, golf carts are an effective and affordable mode of transportation. Much like other modes of transportation, owners of golf carts frequently look to customize their vehicles, such as a with particular color, pattern or the livery of a sports team or university. While traditional custom components such as paint, wraps, lights, and rims are suitable for most of a golf cart, customization of the seats is cumbersome, requiring removal of the seats and custom upholstering or leather onto the padding, including stretching and stapling materials. As such, what is needed is an effective system for customizing the seats of a golf cart.

### SUMMARY OF THE INVENTION

In accordance with embodiments of the invention, a cushion cover system is provided. The cushion cover system includes a removable backrest cushion cover. The removable backrest cushion cover includes a backrest slipcover having a top portion opposite a bottom portion. A peripheral opening is defined by the bottom portion of the backrest slipcover. The removable backrest cushion cover includes at least one buckle operable to secure a first side of the peripheral opening to a second side of the peripheral opening of the backrest slipcover. The cushion cover system includes a removable seat cushion cover. The removable seat cushion cover includes a seat slipcover having a top portion opposite a bottom portion. A peripheral opening is defined by the bottom portion of the seat slipcover. The removable seat cushion cover includes at least one buckle operable to secure a first side of the peripheral opening to a second side of the peripheral opening of the seat slipcover. The backrest slipcover is operable to receive and secure a backrest cushion through the peripheral opening in the bottom portion of the backrest slipcover and the buckle is operable to secure the backrest cushion within the backrest slipcover. The seat slipcover is operable to receive and secure a seat cushion through the peripheral opening in the bottom portion of the seat slipcover and the buckle is operable to secure the seat cushion within the seat slipcover.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts a top view of a removable backrest cushion cover secured on a backrest cushion of a back seat of a golf cart in accordance with embodiments of the invention.

FIG. 2 depicts a bottom view of a removable backrest cushion cover over a backrest cushion of a back seat of a golf cart prior to the tightening of buckles in accordance with embodiments of the invention.

FIG. 3 depicts a bottom view of a removable backrest cushion cover over a backrest cushion of a back seat of a golf cart after the tightening of buckles in accordance with embodiments of the invention.

FIG. 4 depicts a top view of a removable backrest cushion cover secured on a backrest cushion of front seat of a golf cart in accordance with embodiments of the invention.

FIG. 5 depicts a bottom view of a removable backrest cushion cover over a backrest cushion of a front seat of a golf cart prior to the tightening of buckles in accordance with embodiments of the invention.

FIG. 6 depicts a bottom view of a removable backrest cushion cover over a backrest cushion of a front seat of a golf cart after the tightening of buckles in accordance with embodiments of the invention.

FIG. 7 depicts a top view of a removable seat cushion cover secured on a seat cushion of a seat of a golf cart in accordance with embodiments of the invention.

FIG. 8 depicts a bottom view of a removable seat cushion cover over a seat cushion of a seat of a golf cart prior to the tightening of buckles in accordance with embodiments of the invention.

FIG. 9 depicts a bottom view of a removable seat cushion cover over a seat cushion of a seat of a golf cart after the tightening of buckles in accordance with embodiments of the invention.

FIG. 10 depicts a bottom view of a removable backrest cushion cover in accordance with embodiments of the invention.

FIG. 11 depicts a bottom view of a removable backrest cushion cover partially over a backrest cushion of a front seat of a golf cart in accordance with embodiments of the invention.

FIG. 12 depicts a perspective view of a removable backrest cushion cover partially over a backrest cushion of a front seat of a golf cart in accordance with embodiments of the invention.

FIG. 13 depicts a bottom view of a removable seat cushion cover in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

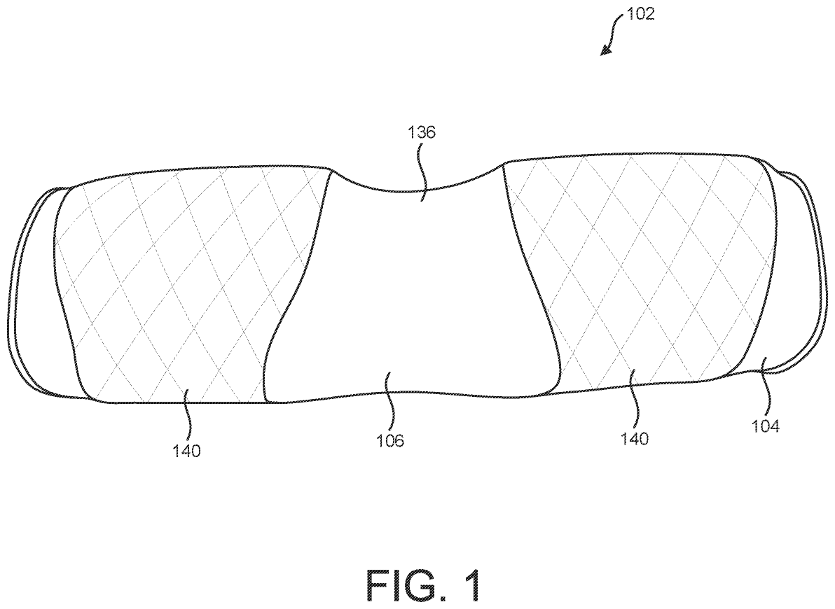

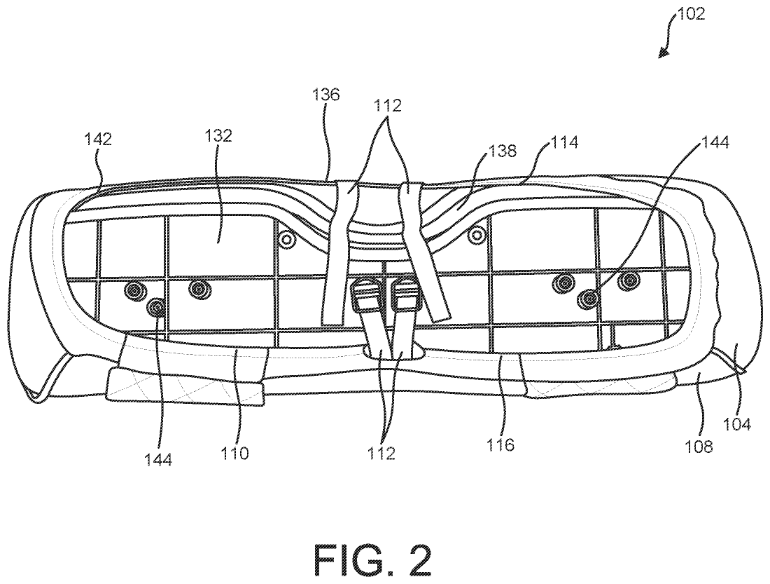

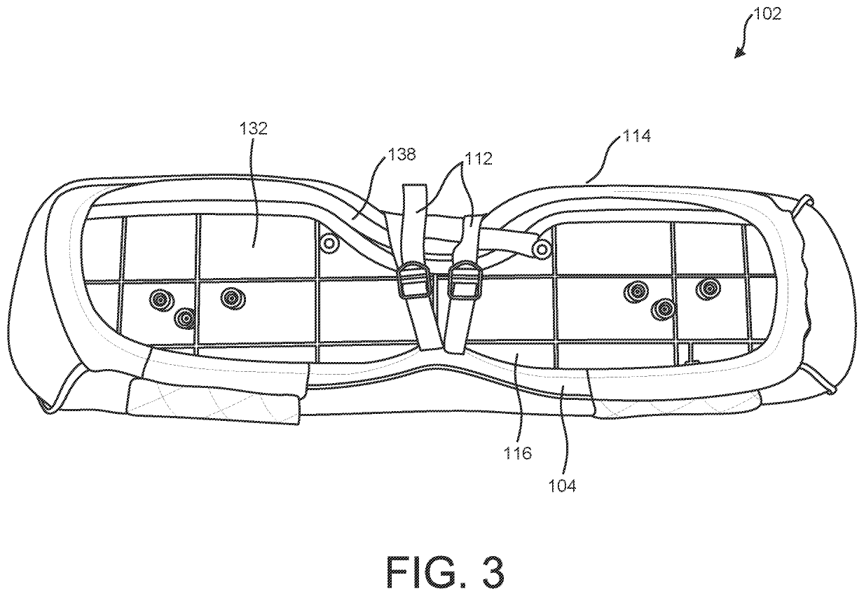

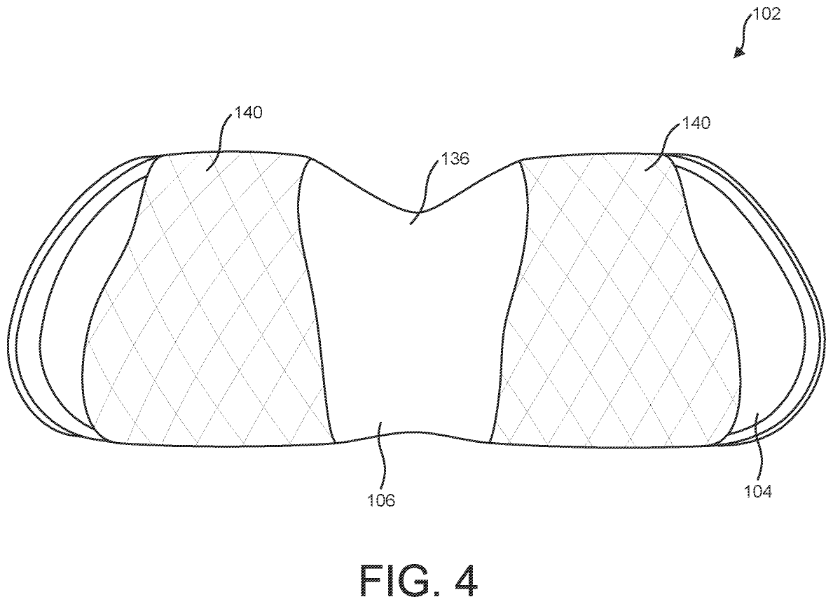

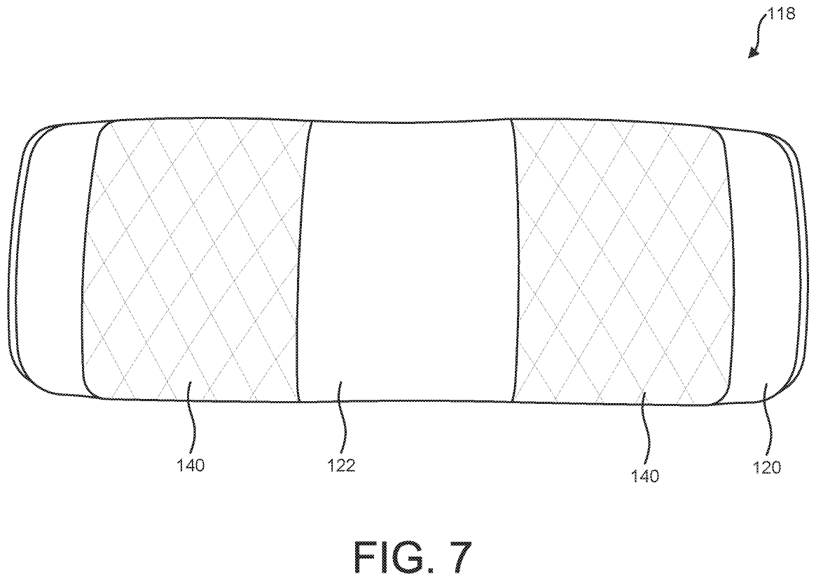

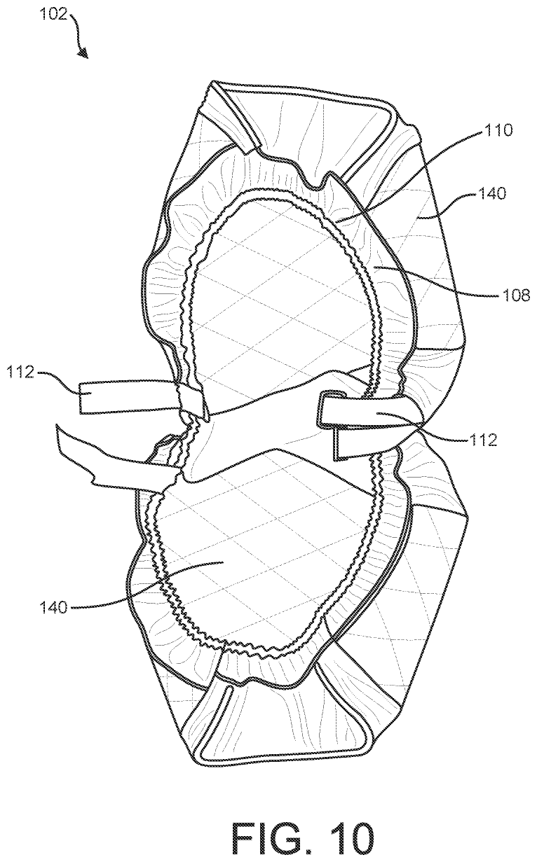

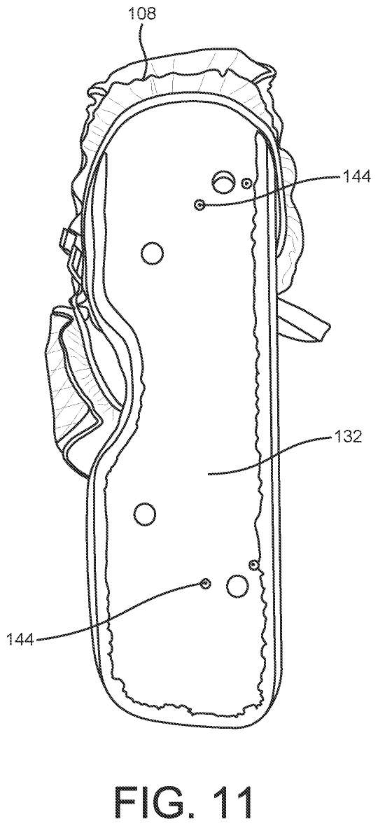

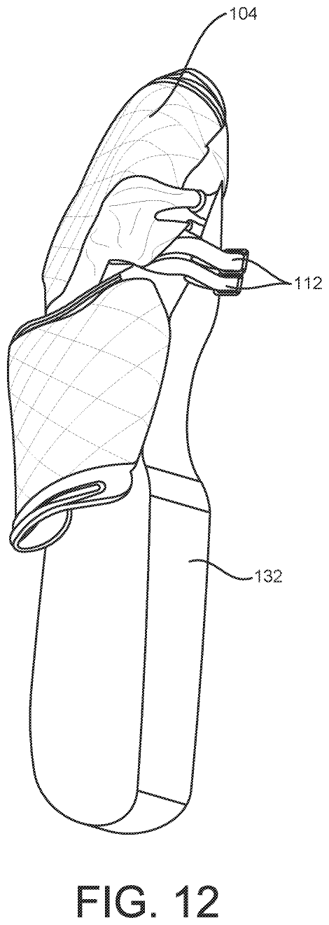

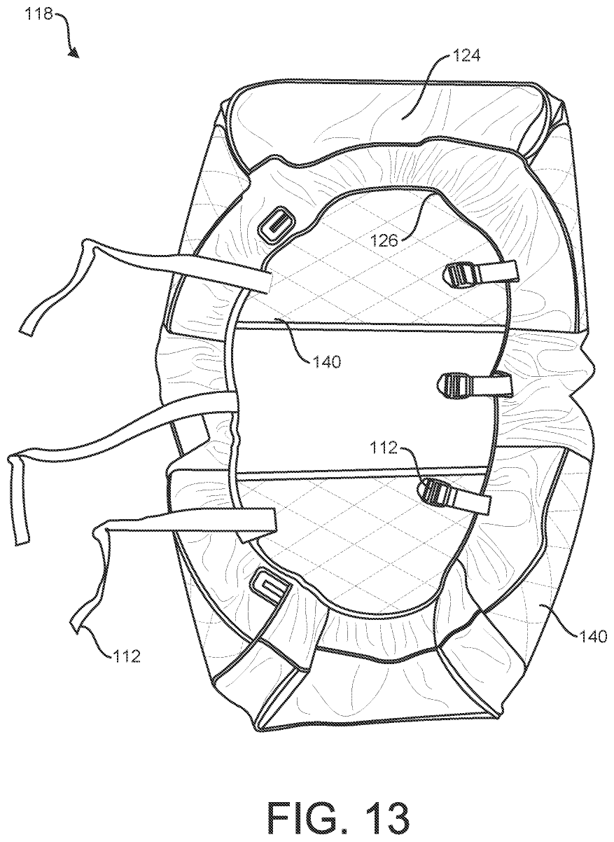

In accordance with embodiments of the invention, a cushion cover system 100 is provided, as illustrated in FIGS. 1-13. Referring to FIGS. 1-6 and 10-12, the cushion cover system 100 includes a removable backrest cushion cover 102. The removable backrest cushion cover 102 includes a backrest slipcover 104 having a top portion 106 opposite a bottom portion 108. A peripheral opening 110 is defined by the bottom portion 108 of the backrest slipcover 104. As illustrated in the Figures, the removable backrest cushion cover 102 includes at least one buckle 112 operable to secure a first side 114 of the peripheral opening 110 to a second side 116 of the peripheral opening 110 of the backrest slipcover 104. The buckles 112 may be adjustable slide release buckles, slider buckles, or belt style buckles, for example. Any type of suitable releasable attachment mechanism may be substituted for the buckles 112. The cushion cover system 100 includes a removable seat cushion cover 118 as illustrated in FIGS. 7-9 and 13. The removable seat cushion cover 118 includes a seat slipcover 120 having a top portion 122 opposite a bottom portion 124. A peripheral opening 126 is defined by the bottom portion 124 of the seat slipcover 120. The removable seat cushion cover 118 includes at least one buckle 112 operable to secure a first side 128 of the peripheral opening 126 to a second side 130 of the peripheral opening 126 of the seat slipcover 120. The backrest slipcover 104 is operable to receive and secure a backrest cushion 132 through the peripheral opening 110 in the bottom portion 108 of the backrest slipcover 104 and the buckle 112 is operable to secure the backrest cushion 132 within the backrest slipcover 104. The seat slipcover 120 is operable to receive and secure a seat cushion 134 through the peripheral opening 126 in the bottom portion 124 of the seat slipcover 120 and the buckle 112 is operable to secure the seat cushion 134 within the seat slipcover 120.

In one embodiment, removable backrest cushion cover 102 defines a concave portion 136 operable to conform to a concave portion 138 of a backrest cushion 132. One or more buckles 112 of the removable backrest cushion cover 102 is operable to secure the first side 114 of the peripheral opening 110 to the second side 116 of the peripheral opening 110 of the backrest slipcover 104 adjacent to the concave portion 136.

In one embodiment, the removable backrest cushion cover 102 and the removable seat cushion cover 118 include at least one pad. The pad 140 may be operable to provide support or rigidity to passenger and may be a color or a pattern to provide a level of customization. As illustrated, the removable backrest cushion cover 102 and the removable seat cushion cover 118 each include a pad 140 for each position of a passenger of a golf cart. The cushion covers may be made from leather, fabric, or marine grade vinyl, for example. The pads 140 may be made of any suitable padding, such as a marine grade vinyl color dyed with an extra foam padding.

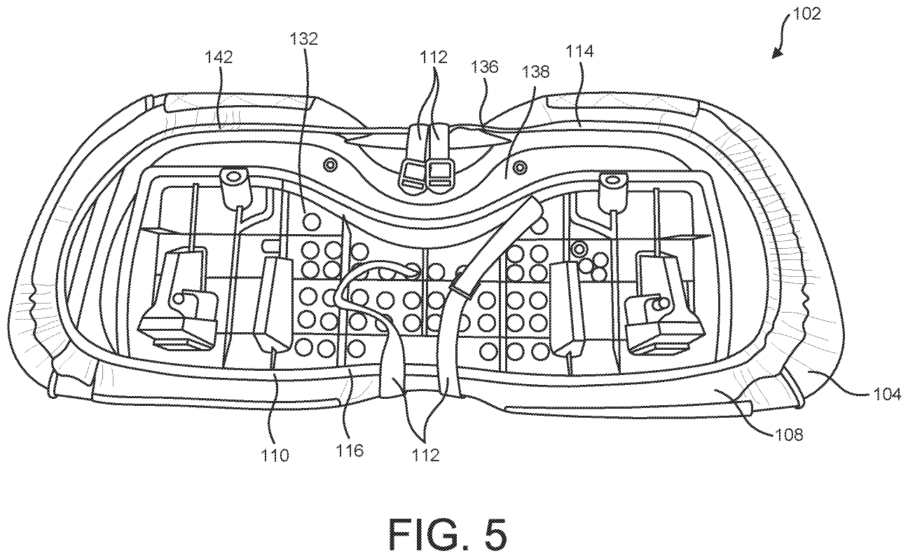

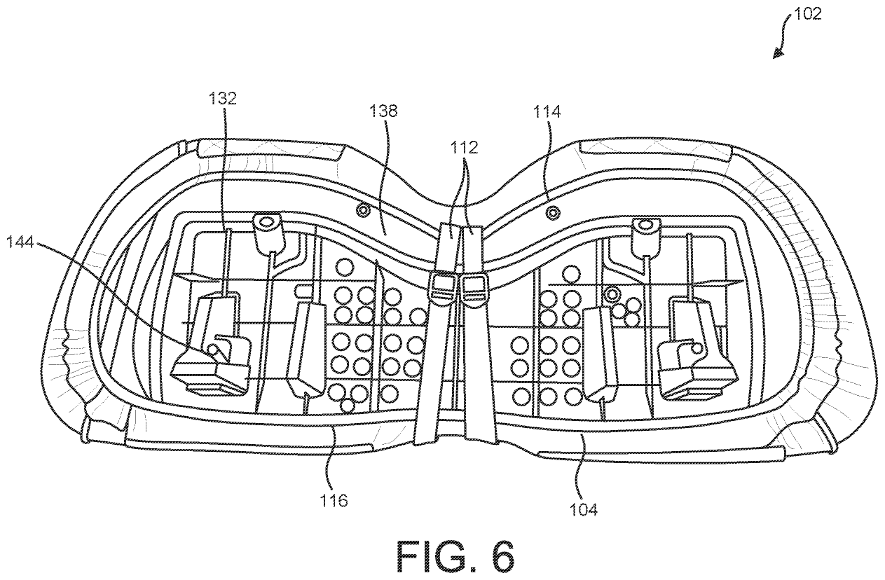

In the embodiment illustrated in the FIGS. 5-6, the bottom portion 108 of the removable backrest cushion cover 102 extends partially over and around a periphery of the backrest cushion 132 to enable access to connection points, such as threaded holes 144. The peripheral opening 110 of the removable backrest cushion cover 102 comprises an elastomeric member 142 to enable the removable backrest cushion cover 102 to securely fit around the backrest cushion 132. The removable backrest cushion cover 102 may be double stitched around the elastomeric member 142 for reinforcement to prevent tearing. The buckles 112 are tightened to securely fasten the removable backrest cushion cover 102 to the backrest cushion 132.

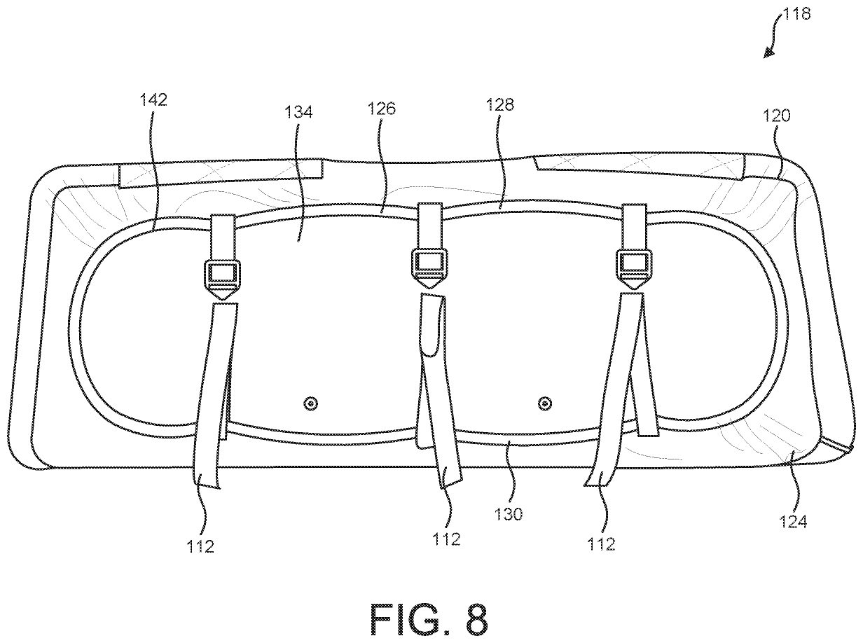

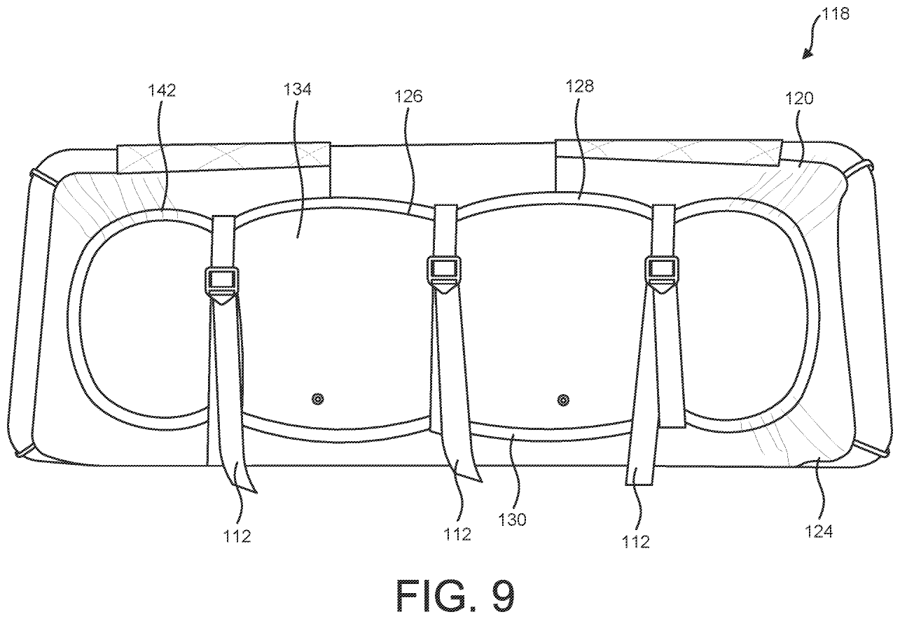

In the embodiment illustrated in the FIGS. 8-9, the bottom portion 124 of the seat cushion cover 118 extends partially over and around a periphery of the seat cushion 134 to enable access to connection points, such as threaded holes 144. The peripheral opening 126 of the removable seat cushion cover 102 comprises an elastomeric member 142 to enable the seat cushion cover 102 to securely fit around the seat cushion 134. The removable seat cushion cover 118 may be double stitched around the elastomeric member 142 for reinforcement to prevent tearing. The buckles 112 are tightened to securely fasten the seat cushion cover 134 to the seat cushion 134.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A removable cushion cover system, comprising:
a removable backrest cushion cover, comprising:
a backrest slipcover, said backrest slipcover having a top portion opposite a bottom portion;
a peripheral opening defined by said bottom portion of said backrest slipcover; and
at least one buckle, said at least one buckle operable to secure a first side of said peripheral opening to a second side of said peripheral opening of said backrest slipcover; and
a removable seat cushion cover, comprising:
a seat slipcover, said seat slipcover having a top portion opposite a bottom portion;
a peripheral opening defined by said bottom portion of said seat slipcover; and
at least one buckle, said at least one buckle operable to secure a first side of said peripheral opening to a second side of said peripheral opening of said seat slipcover;
wherein said backrest slipcover is operable to receive and secure a backrest cushion through said peripheral opening in said bottom portion of said backrest slipcover and wherein said buckle is operable to secure said backrest cushion within said backrest slipcover; and
wherein said seat slipcover is operable to receive and secure a seat cushion through said peripheral opening in said bottom portion of said seat slipcover and wherein said buckle is operable to secure said seat cushion within said seat slipcover.

2. The removable cushion cover system of claim 1, wherein said removable backrest cushion cover defines a concave portion operable to conform to a concave portion of a backrest cushion.

3. The removable cushion cover system of claim 2, wherein said at least one buckle of said removable backrest cushion cover is operable to secure said first side of said peripheral opening to said second side of said peripheral opening of said backrest slipcover adjacent to said concave portion.

4. The removable cushion cover system of claim 1, wherein said a removable backrest cushion cover further comprises at least one pad.

5. The removable cushion cover system of claim 1, wherein said a removable seat cushion cover further comprises at least one pad.

6. The removable cushion cover system of claim 1, wherein said peripheral openings of said removable backrest cushion cover and said removable seat cushion cover each comprise an elastomeric member.

7. The removable cushion cover system of claim 1, wherein said bottom portion of said backrest slipcover is operable to extend partially over and around a periphery of said backrest cushion.

8. The removable cushion cover system of claim 1, wherein said bottom portion of said seat slipcover is operable to extend partially over and around a periphery of said seat cushion.

9. A removable cushion cover, comprising:
a slipcover, said slipcover having a top portion opposite a bottom portion;
a peripheral opening defined by said bottom portion of said slipcover;
at least one buckle, said at least one buckle operable to secure a first side of said peripheral opening to a second side of said peripheral opening; and
wherein said slipcover is operable to receive and secure a cushion through said peripheral opening in said bottom portion of said slipcover and wherein said buckle is operable to secure said cushion within said slipcover.

10. The removable cushion cover of claim 9, further comprising at least one pad.

11. The removable cushion cover of claim 9, wherein said peripheral opening comprises an elastomeric member.

12. The removable cushion cover system of claim 9, wherein said removable backrest cushion cover defines a concave portion operable to conform to a concave portion of a backrest cushion.

13. The removable cushion cover system of claim 9, wherein said at least one buckle of said removable backrest cushion cover is operable to secure said first side of said peripheral opening to said second side of said peripheral opening of said backrest slipcover adjacent to said concave portion.

14. The removable cushion cover system of claim 9, wherein said bottom portion of said slipcover is operable to extend partially over and around a periphery of said cushion.
